(19) United States
(12) Patent Application Publication
(10) Pub. No.: US 2018/0210532 A1
(43) Pub. Date: Jul. 26, 2018

(54) Method and Apparatus for Implementing Heterogeneous Frequency Operation and Scheduling Task of Heterogeneous Frequency CPU

(71) Applicant: ALIBABA GROUP HOLDING LIMITED, George Town (KY)

(72) Inventors: Xiantao ZHANG, Hangzhou (CN); Yang ZHANG, Shanghai (CN)

(73) Assignee: ALIBABA GROUP HOLDIING LIMITED

(21) Appl. No.: 15/876,064

(22) Filed: Jan. 19, 2018

(30) Foreign Application Priority Data
Jan. 20, 2017 (CN) 201710045835.2

(51) Int. Cl. G06F 1/32; G06F 9/48; G06F 9/50

(52) U.S. Cl. CPC G06F 1/324; G06F 9/5083; G06F 9/5094; G06F 9/4881

(57) ABSTRACT

A heterogeneous-frequency CPU, a method and an apparatus for implementing heterogeneous frequencies, and a task scheduling method are provided. The CPU includes multiple cores, and the multiple cores have a same function but different operating frequencies of hardware. The method for implementing heterogeneous frequencies includes: determining a plurality of preset operating frequencies of the plurality of cores after the CPU starts; setting the operating frequency of each core of the plurality of cores at a respective preset operating frequency; and maintaining the set operating frequencies throughout performance of the cores. The disclosed heterogeneous-frequency CPU has stable computing performance when demand and requirements of services constantly change. The operating system can schedule a service to a core having an operating frequency that matches the service.

### CROSS REFERENCE TO RELATED APPLICATION

The present application is based on and claims the benefits of priority to Chinese Application No. 201710045835.2, filed Jan. 20, 2017, the entire contents of which are incorporated herein by reference.

### TECHNICAL FIELD

The present disclosure relates to the field of computers, and in particular, to a CPU having multiple cores, a method and an apparatus for setting a frequency for a core, and a task scheduling method.

### BACKGROUND

A core is an independent computing unit inside each CPU. The unit is physically independent, and has independent resources. For example, a CPU can physically be divided into a GPU, four cores, a shared L3 cache, a memory controller, and other parts. Each core has respective independent resources such as an L1/L2 cache, a register, a computing part, and an operating frequency, as well as some shared resources such as L3 cache, an uncore clock, etc. Each core of an X86 CPU occupies a same size of physical area.

An X86 CPU can support multiple cores that have a same function. The cores have respective exclusive resources as well as shared resources between them. By configuring different cores differently by software, a frequency of each core can be independently controlled and set, but at the same time it is also limited by a condition (such as temperature, heat dissipation, power consumption, and the like) of the entire CPU. Each core can ensure a reference frequency, and in appropriate situations, can also achieve a higher frequency. The core can operate for a period of time at the higher frequency until certain conditions are triggered (e.g., temperature is too high, power consumption exceeds thermal design power (TDP), and the like). For example, in the solution of Per Core P-State, an assurable frequency is determined according to the headroom (power consumption, heat dissipation, and the like) remaining inside the CPU. This frequency is higher than the reference frequency but lower than the highest frequency. Therefore it's a tradeoff solution. In addition, the frequency is affected by the load of other cores in the same CPU and heat dissipation and power consumption of the entire CPU, and the multiple cores contend freely. Therefore, whether the core can operate at a higher frequency and how long the core can operate at the higher frequency is not guaranteed.

Accordingly, the performance of a multi-core CPU is not stable in situations when demand and requirements of services constantly change. For example, in a scenario of cloud computing, different from a local computing center, network services and storage services thereof need to be implemented by software. In a de-computing system, tasks that software is required to complete include network service, storage service, general services, and the like. The network service and the storage service require better computing capability, such as a higher computing speed, while general services do not require such high computing capability. Better computing capability imposes a higher requirement on operating frequencies of the cores. However, with X86 CPU adopting the aforementioned technology, although some cores thereof can achieve a relatively high frequency, it cannot be guaranteed that the cores continuously operate at the relatively high frequency.

Under current technologies, each individual core has no fixed operating frequency. Instead, the operating frequency can be increased when allowed by temporal power consumption, heat dissipation, and other conditions. After the increase, the operating frequency can also be reduced due to changes in power consumption and heat dissipation. Therefore, the solution cannot guarantee a constant performance. The core that runs the general services may consume more power when workload of the general services is relatively heavy. As a result, the overall power consumption of the CPU increases, and the operating frequency of the core that runs a storage service has to be reduced in the scenario. Therefore, the existing CPU still needs to be improved.

### SUMMARY OF THE INVENTION

Embodiments of the present disclosure provide a heterogeneous-frequency CPU with multiple cores. The multiple cores have a same function but multiple operating frequencies of their hardware.

The embodiments of the present disclosure further provide a method for implementing heterogeneous frequencies of a CPU having multiple cores. The method includes determining preset operating frequencies of the multiple cores after the CPU starts, the multiple cores having multiple preset operating frequencies, and setting the operating frequencies of the multiple cores at the respective preset operating frequencies and maintaining the multiple cores to work at the set operating frequencies during operation.

The embodiments of the present disclosure further provide an apparatus for implementing heterogeneous frequencies of a CPU having multiple cores. The apparatus includes a frequency determination module configured to determine preset operating frequencies of the multiple cores after the CPU starts, the multiple cores having multiple preset operating frequencies; and a frequency setting module configured to set the operating frequencies of the multiple cores at respective preset operating frequencies and maintain the multiple cores to work at the set operating frequencies during operation.

The foregoing solution can provide a heterogeneous-frequency CPU by means of hardware or software, and has stable computing performance when demand and requirements of services constantly change.

The embodiments of the present disclosure further provide a task scheduling method, which is applied to a computer, wherein the CPU of the computer has multiple cores operating at multiple frequencies. The method includes determining in the multiple cores, by an operating system of the computer upon receiving a task, a core having an operating frequency matching the task; and scheduling, by the operating system, the task to the determined core for performing.

The embodiments of the present disclosure further provide a computer operating system, wherein the CPU of the computer has multiple cores operating at multiple frequencies. The computer operating system includes a task scheduling module, and the task scheduling module includes a core selection unit configured to determine in the multiple cores, upon receiving a task, a core having an operating frequency matching the task; and a task scheduling unit configured to schedule the task to the determined core for performing.

The foregoing solution schedules, based on a heterogeneous-frequency CPU, a service to a core whose operating frequency matches the service. Accordingly, the solution can meet the differential performance requirements of services when demand and requirements of services constantly change.

### BRIEF DESCRIPTION OF THE DRAWINGS

FIG. 1 is a schematic diagram illustrating an exemplary standard operating frequency CPU.

FIG. 2 is a schematic diagram illustrating an exemplary heterogeneous-frequency CPU, consistent with embodiments of the present disclosure.

FIG. 3 is a flowchart illustrating an exemplary method for implementing heterogeneous frequencies of a CPU having multiple cores, consistent with embodiments of the present disclosure.

FIG. 4 is a modular diagram illustrating an exemplary apparatus for implementing heterogeneous frequencies of a CPU having multiple cores, consistent with embodiments of the present disclosure.

FIG. 5 is a flowchart illustrating an exemplary task scheduling method for implementing heterogeneous frequencies of a CPU having multiple cores, consistent with embodiments of the present disclosure.

FIG. 6 is a schematic diagram illustrating exemplary units of a task scheduling module for implementing heterogeneous frequencies of a CPU having multiple cores, consistent with embodiments of the present disclosure.

### DETAILED DESCRIPTION

In order to make the objectives, technical solutions, and advantages of the present disclosure more comprehensible, the embodiments of the present disclosure are described in detail in the following with reference to the accompanying drawings. It should be noted that the embodiments in the present application and the features in the embodiments can be mutually combined arbitrarily in the absence of a conflict.

There are conventional solutions of setting and adjusting operating frequencies of cores, such as the solution of Per Core P-State, multiple cores in a same CPU are identical at function and operating frequency. The demand for heterogeneous frequencies of a CPU is not noticed or taken care of. Operating frequencies of core hardware of multi-core CPUs in different generations are generally different, and operating frequencies of multi-core CPUs in next generation designs are generally higher than their precedent generations. However, the existing multi-core CPU cannot meet performance requirements in some scenarios.

The embodiments of the present disclosure provide a heterogeneous-frequency CPU. The CPU includes multiple cores. The multiple cores have a same function but multiple operating frequencies of their hardware, or the operating frequencies of their hardware are not all the same. For example, the multiple cores may be divided into two groups, three groups or four groups. Operating frequencies of cores in a same group can be the same, while operating frequencies of cores in different groups are different.

In addition, in some embodiments, the multiple cores in the CPU may have multiple operating frequencies of hardware, but functions of the cores are the same. The same function is implemented based on a same architecture where circuit units for implementing corresponding functions can be the same. However, it is not necessary that devices and components of these circuit units, as well as performance time, efficiency, and power consumption of these circuit units, are the same. No matter which core performs a task, functions and states of the task are the same, although operating frequencies of cores can be different.

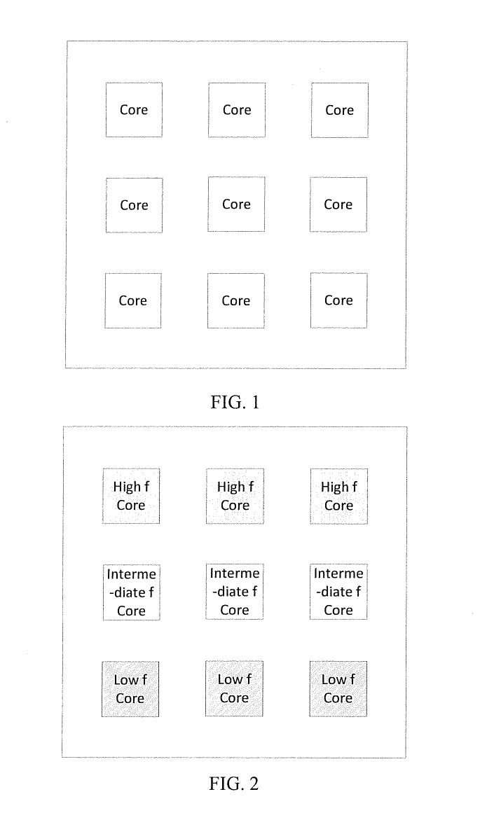

Reference is now made to FIG. 1, which is a schematic diagram illustrating an exemplary standard operating frequency CPU. In FIG. 1, the CPU has nine cores and each of them is configured to work at a standard operating frequency. Each of the nine cores is capable of working at different operating frequencies at different time. It is a configurable method by software. As explained above, however, operating frequencies of these cores can fluctuate based on the resources of the CPU itself. For example, while operating at a reference frequency, each core can spontaneously operate at a higher frequency for some time under certain conditions. But this higher frequency may not always be available because the certain conditions may not last until a requested service is completed, operating frequencies of cores may fluctuate, thereby creating instability within the CPU. Moreover, when a higher frequency is set for one or more cores, other cores can be adversely affected due to contention of resource. Accordingly, this spontaneity can create an unstable CPU. Working at a higher frequency is a transient state that may not last.

The disclosed embodiments overcome the issues of the prior art, by providing a heterogeneous architecture that predetermines different resource configurations for each core. In particular, for each resource configuration, the operating frequencies are set and maintained for each core, thereby providing a more stable CPU by deliberately allocating the CPU's resources across all of the cores.

Reference is now made to FIG. 2, which illustrates an exemplary heterogeneous architecture, consistent with embodiments of the present disclosure. In this exemplary heterogeneous architecture, the CPU has nine cores, in which three are set to work at a higher frequency as high-frequency cores, three are configured to work at an intermediate frequency as intermediate-frequency cores, and the remaining three are configured to work at a lower frequency as low-frequency cores. To maintain the performance of high-frequency cores, the CPU can compress the configured low-frequency cores and normal-frequency cores in terms of power consumption, temperature, and can even compress the overall number of cores of the CPU.

As an example, a high-frequency core has a hardware operating frequency of 133 MHz, an intermediate-frequency core has a hardware operating frequency of 100 MHz, and a low-frequency core has a hardware operating frequency of 66 MHz. In some embodiments, some adjustments of frequencies can be made within a narrow range, but such adjustments are to be limited to avoid overlaps of frequencies between multiple cores working at different categories of operating frequency, to meet different requirements of performance imposed by different tasks. That is, the operating frequencies of the high-frequency cores are maintained at a high-frequency range, the operating frequencies of the intermediate-frequency cores are maintained at an intermediate-frequency range, and the operating frequencies of the low-frequency cores are maintained at a low-frequency range. The terms “high”, “intermediate”, and “low” here are relative.

In some embodiments, the operating frequencies of the cores are maintained. Frequencies are selected in accordance with specifications of the cores of the CPU, such as power consumption, temperatures, heat dissipation, and other conditions of each core. Therefore, abnormalities such as an excessively high temperature of the CPU are not caused when the cores operate at respective frequencies.

In some embodiments, by selecting cores that have different operating frequencies in a same CPU, stable computing performance can be provided when demand and requirements of services change, and the operating frequencies of the high-frequency cores can be guaranteed even if power consumption and heat dissipation of other cores change. Therefore, high-performance computing service can be maintained.

The foregoing embodiments provide a solution of implementing heterogeneous frequencies by hardware. In these embodiments, heterogeneous frequencies are implemented by software, and heterogeneity is implemented by setting operating frequencies of multiple cores in a CPU by configurations made with software.

Reference is now made to FIG. 3, which is a flowchart illustrating an exemplary method for implementing heterogeneous frequencies of a CPU having multiple cores, consistent with embodiments of the present disclosure. These embodiments provide a method for implementing heterogeneous frequencies of a CPU. In these embodiments, heterogeneous frequencies of a CPU are implemented by using a setting mechanism. The CPU includes multiple cores, and multiple operating frequencies of the cores can be set.

As shown in FIG. 3, the method includes: presetting operating frequencies, setting multiple cores to work at operating frequencies, and maintaining the set operating frequencies.

In step 110, preset operating frequencies of the multiple cores are determined after the CPU starts. Each of the multiple cores has a preset working frequency and the multiple cores have multiple preset operating frequencies.

In some embodiments, the multiple preset operating frequencies of the multiple cores can be preset in manufacture before delivered to a user. For example, the core could be configured to operate at each of the high, middle, and low frequencies. The presetting of operating frequencies of the multiple cores can be implemented by hardware topology or software configuration, which can be in the form of programmable codes embedded in a non-transitory computer readable medium electrically connected to the CPU when CPU starts.

In some embodiments, the multiple preset operation frequencies of the multiple cores can be set by a user. The presetting of operating frequencies of the multiple cores can be implemented by hardware topology or software configuration such as through a basic input output system (BIOS).

As a result of the presetting of operating frequencies, each of the multiple cores of the CPU is enabled to work at a preset working frequency. Such setting also provides the possibility that the multiple cores are set to work at multiple working frequencies when the CPU receives task requests, according to the working frequencies required by the nature of the tasks.

In step 120, the operating frequencies of the multiple cores are set at respective preset operating frequencies. The multiple cores are maintained at the set operating frequencies during operation. For example, the frequencies may be implemented by adjusting input voltages of the cores. For instance, the input voltage can be increased to ensure that a core's operating frequency can be maintained at a relatively high level. For another core, the input voltage can be lowered, thereby allowing that core to operate at a less modest level.

Although in these embodiments the frequencies of the cores are also set by software, it is different from Per Core P-State. In these embodiments, after the operating frequencies of the cores are preset, these operating frequencies are maintained during the process of operation. The cores operate at the preset operating frequencies. The cores do not contend freely, and are not affected by power consumption and other factors of the CPU chip.

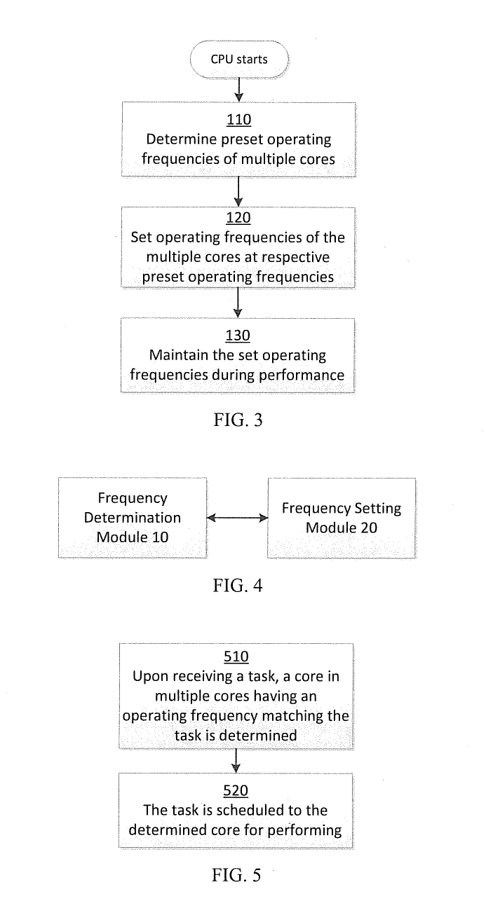

Reference is now made to FIG. 4, which is a modular diagram illustrating an exemplary apparatus for implementing heterogeneous frequencies of a CPU having multiple cores, consistent with embodiments of the present disclosure. As shown in FIG. 4, the apparatus includes a frequency determination module 10 configured to determine preset operating frequencies of the multiple cores after the CPU starts, the multiple cores having multiple preset operating frequencies; and a frequency setting module 20 configured to set the operating frequency of each core of the multiple cores at a respective preset operating frequency, and maintain the multiple cores operating at the set operating frequencies throughout performance of the cores during a resource configuration.

Multiple cores in the CPU can have a same function or different functions.

In these embodiments, heterogeneous frequencies of a CPU are implemented by software setting, and differential computing performance can be provided. The operating frequencies of the high-frequency cores can be guaranteed even if power consumption and heat dissipation of other cores change. Therefore, high-performance computing service can be provided for certain services constantly.

Heterogeneous frequencies of a CPU in the foregoing embodiments are designed to meet differential requirements of services for computing performance. Moreover, the solution of implementing heterogeneous frequencies of a CPU in the foregoing embodiments can guarantee the number of the cores, and meet service demands by providing cores at different frequencies for different service scenarios.

Reference is now made to FIG. 5, which is a flowchart illustrating an exemplary task scheduling method for implementing heterogeneous frequencies of a CPU having multiple cores, consistent with embodiments of the present disclosure. These embodiments provide a task scheduling method based on the aforementioned heterogeneous-frequency CPU implemented by hardware or software. The method is applied to a computer having a CPU with multiple cores, and these multiple cores have multiple operating frequencies. As shown in FIG. 5, the method includes: determining a core having matching operating frequency with a task, and scheduling the task to the determined core to perform.

In step 510, an operating system of the computer determines, upon receiving a task, a core in the multiple cores having an operating frequency matching the task.

In these embodiments, the operating system determines a core of the multiple cores having an operating frequency that matches the task according to a configured corresponding relation between task type and the core. The corresponding relationship between task types and cores may be configured by a user by using an interface provided by the operating system of the computer. In these embodiments, the operating system of the computer does not directly perceive a relationship between working frequencies and received tasks, while the corresponding relationship between task type and core is configured by a user.

In some embodiments, the operating system determines a corresponding relation between task types and cores according to operating frequencies required by task types and the operating frequencies of the multiple cores, and further determines a core of the multiple cores having an operating frequency that matches the operating frequency required by the task in accordance with its task type. In these embodiments, the operating frequencies required by task types may be configured by a user or configured by default values set in manufacture. An algorithm to determine the corresponding relationship between task types and cores can be used in the operating system to confirm the corresponding relationship according to the operating frequencies of the core. A corresponding relationship may be determined and stored in advance. Upon receiving a task, a core in the multiple cores having an operating frequency that matches the task is then determined in accordance with its task type.

Task type of a task may be represented with priority, and different priorities represent different task types. Task type of a task may also be represented directly with service type of a service related to the task, or represented with another defined label, which is not limited in the present disclosure.

In step 520, the operating system schedules the task to the determined core for performing. The operating frequency of the determined core matches the task. For example, a cloud computing server may provide storage service, network service, and other general services. For storage services and network services that have higher requirements on computing performance, tasks related thereto are matched to high-frequency cores or intermediate-frequency cores, while other general services can be matched to low-frequency cores. With the disclosed method, the performance requirements of storage service and network service can be met.

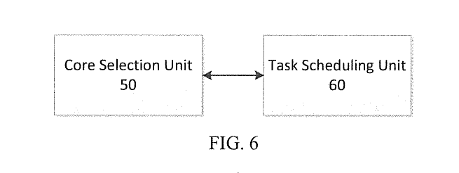

Reference is now made to FIG. 6, which is a schematic diagram illustrating exemplary units of a task scheduling module for implementing heterogeneous frequencies of a CPU having multiple cores, consistent with embodiments of the present disclosure. The multiple cores have multiple operating frequencies, and the computer operating system includes a task scheduling module. As shown in FIG. 6, the task scheduling module includes a core selection unit and a task scheduling unit. Core selection unit 50 is configured to determine, upon receiving a task, a core in the multiple cores having an operating frequency that matches the task. Task scheduling unit 60 is configured to schedule the task to the determined core for performing.

Core selection unit 50 can be configured to determine a core in the multiple cores having an operating frequency that matches the task according to its task type and a corresponding relationship between task types and cores. Core selection unit 50 can also be configured to determine a corresponding relationship between task types and cores according to operating frequencies required by task types and operating frequencies of the multiple cores, and further determine a core in the multiple cores having an operating frequency that matches the task in accordance with its task type.

Based on a heterogeneous-frequency CPU, the disclosed task scheduling module schedules a task to a core having an operating frequency that matches the task. Differential requirements of performance can be met.

Based on foregoing description of embodiments, it is appreciated that the methods of the above embodiments may be implemented by software in combination with hardware or by hardware only. Based on such an understanding, the technical solutions of the embodiments of the present disclosure may be substantially implemented in the form of a software product (which would include any firmware). The computer software product may be stored in a non-transitory computer readable medium (such as a ROM/RAM, a magnetic disk, flash memory, or an optical disk), and include several instructions for instructing a terminal device (which may be a mobile phone, a computer, a server, a network device, and the like) to perform the methods according to the embodiments of the present disclosure.

The disclosed modules/units can be a packaged functional hardware unit designed for use with other components (e.g., portions of an integrated circuit) and/or a part of a program (stored on a computer readable medium) that performs a particular function of related functions. The one or more modules can have entry and exit points and can be written in a programming language, such as, for example, Java, Lua, C, or C++. A software module can be compiled and linked into an executable program, installed in a dynamic link library, or written in an interpreted programming language such as, for example, BASIC, Perl, or Python. It will be appreciated that software modules can be callable from other modules or from themselves, and/or can be invoked in response to detected events or interrupts. Software modules configured for execution on computing devices can be provided on a non-transitory computer readable medium, such as a compact disc, digital video disc, RAM, ROM, flash drive, or any other non-transitory medium, or as a digital download (and can be originally stored in a compressed or installable format that requires installation, decompression, or decryption prior to execution). Such software code can be stored, partially or fully, on a memory device of the executing computing device, for execution by one or more processors. Software instructions can be embedded in firmware, such as an EPROM. It will be further appreciated that hardware modules can be comprised of connected logic units, such as gates and flip-flops, and/or can be comprised of programmable units, such as programmable gate arrays or processors.

The specification and the embodiments are merely regarded as examples, and the real scope and spirit of the present application are indicated by the following claims. It should be understood that the present application is not limited to the precise structure that has been described above and shown in the accompanying drawings, and various modifications and changes can be made without departing from the scope thereof. The scope of the present application is merely limited by the appended claims.

1. A heterogeneous-frequency CPU comprising a plurality of cores configured to operate based on a resource configuration of the CPU, wherein one or more cores of the plurality of cores are preset to operate and maintain a higher frequency during the resource configuration and one or more other cores are preset to operate and maintain a lower frequency during the resource configuration.

2. The CPU of claim 1, wherein the plurality of cores are divided into more than one group, and operating frequencies of cores in a same group are preset to be the same, and operating frequencies of cores in different groups are preset to be different.

3. A method for implementing heterogeneous frequencies of a CPU comprising a plurality of cores, the method comprises:
determining a plurality of preset operating frequencies of the plurality of cores after the CPU starts;
setting the operating frequency of each core of the plurality of cores at a respective preset operating frequency; and
maintaining the set operating frequencies of the cores.

4. The method of claim 3, wherein the plurality of preset operating frequencies of the plurality of cores are preset in manufacture, or set by a user through a basic input output system (BIOS).

5. The method of claim 3, wherein at least some of the plurality of cores have a same function.

6. An apparatus for implementing heterogeneous frequencies of a CPU comprising a plurality of cores, the apparatus comprises:
a frequency determination module configured to determine preset operating frequencies of the plurality of cores after the CPU starts, the plurality of cores having a plurality of preset operating frequencies; and
a frequency setting module configured to set the operating frequency of each core of the plurality of cores at a respective preset operating frequency, and to maintain the set operating frequencies of the cores for a set resource configuration.

7. The apparatus of claim 6, wherein at least some of the plurality of cores have a same function.

8. A heterogeneous frequency CPU comprising a plurality of cores, wherein the plurality of cores have a same function and a plurality of different hardware operating frequencies.

9. A task scheduling method applied to a computer with a CPU having a plurality of cores, wherein the plurality of cores have a plurality of operating frequencies, comprises:
determining, by an operating system of the computer upon receiving a task, a core of the plurality of cores having an operating frequency corresponding to the frequency requirement of the task; and
scheduling, by the operating system, the task to the determined core for performing.

10. The method of claim 9, wherein determining in the plurality of cores, by the operating system of the computer upon receiving the task, the core having an operating frequency corresponding to the frequency requirement of the task comprises:
determining the core in the plurality of cores having an operating frequency corresponding to the frequency requirement of the task according to task type of the task and a configured corresponding relationship between task types and cores.

11. The method of claim 9, wherein determining in the plurality of cores, by an operating system of the computer upon receiving a task, a core having an operating frequency corresponding to the frequency requirement of the task comprises:
determining a corresponding relationship between task types and cores according to operating frequencies required by task types and operating frequencies of cores; and
determining a core in the plurality of cores having an operating frequency matching the operating frequency required by the task in accordance with task type of the task.

12. A computer operating system, wherein the CPU of the computer comprises a plurality of cores having a plurality of operating frequencies, the computer operating system comprises a task scheduling module, and the task scheduling module comprises:
a core selection unit configured to determine, upon receiving a task, a core in the plurality of cores having an operating frequency corresponding to the frequency requirement of the task; and
a task scheduling unit configured to schedule the task to the determined core for performing.

13. The operating system of claim 12, wherein the core selection unit is further configured to:
determine a core in the plurality of cores having an operating frequency corresponding to the frequency requirement of the task according to task type of the task and a configured corresponding relationship between the task types and cores; or
determine a corresponding relationship between task types and cores according to operating frequencies required by task types and operating frequencies of cores; and
determine a core in the plurality of cores having an operating frequency matching the the operating frequency required by the task in accordance with its task type.

14. A non-transitory computer readable medium storing a set of instructions that is executable by one or more processors of a computer system to cause the computer system to perform a method comprising:
determining a plurality of preset operating frequencies of a plurality of cores of a Central Processing Unit (CPU) after the CPU starts;
setting the operating frequency of each core of the plurality of cores at a respective preset operating frequency; and
providing instructions to maintain the set operating frequencies of the cores.

15. A non-transitory computer readable medium storing a set of instructions that is executable by one or more processors of a computer system to cause the computer system to perform a method comprising:
instructing an operating system of the computer system to determine out of a plurality of cores of a CPU, upon receiving a task, a core having an operating frequency corresponding to the frequency requirement of the task; and
instructing the operating system to schedule the task to the determined core for performing, wherein
the plurality of cores of the CPU of the computer have a plurality of different operating frequencies.
